(19) United States
(12) Patent Application Publication
(10) Pub. No.: US 2015/0088556 A1
(43) Pub. Date: Mar. 26, 2015

(54) SYSTEMS AND METHODS FOR PROCESSING PROPERTY INSURANCE

(71) Applicant: STATE FARM MUTUAL AUTOMOBILE INSURANCE COMPANY, Bloomington, IL (US)

(72) Inventors: Ryan Convery, Cumming, GA (US); Timothy Kiper, Normal, IL (US); Dwayne Taylor, Bloomington, IL (US); Brad M. Johnson, Charlottesville, VA (US); Shanda Bass, Bloomington, IL (US); Craig Cornwell, Deer Creek, IL (US); Matthew Cuttell, Bloomington, IL (US); Stacy Whitmer, Bloomington, IL (US); Jennifer Huffman, Bloomington, IL (US)

(73) Assignee: STATE FARM MUTUAL AUTOMOBILE INSURANCE COMPANY, Bloomington, IL (US)

(21) Appl. No.: 14/036,970

(22) Filed: Sep. 25, 2013

(51) Int. Cl. G06Q 40/08

(52) U.S. Cl. CPC G06Q 40/08
USPC 705/4

(57) ABSTRACT

Methods and systems for processing property insurance are provided. According to embodiments, an insurer can process an insurance application for a property by determining a property rating score that reflects a need to conduct a manual inspection of the property. The insurer can apply a set of business rules or metrics to additional property data to further refine the decision of whether to conduct a manual inspection of the property as well as the decision of whether to issue a property insurance policy for the property. By not requiring a manual inspection, both the insurer and the insured may realize reduced costs.

### FIELD OF THE DISCLOSURE

This disclosure generally relates to processing property insurance for various properties, and in particular, to analyzing information and data associated with the properties to determine if a manual inspection is needed to approve property insurance policies.

### BACKGROUND

Generally speaking, property insurance covers private homes or properties from various losses occurring to the properties, their contents, loss of their use, and/or loss of personal possessions of the property owners. In some cases, property insurance can include liability insurance for any accidents that may happen at the properties. Depending on the coverage selected by the policyholder, some of the cost of the property insurance policy may include the cost to repair or replace the property and/or possessions therein that are included in the property.

Insurance providers often evaluate the risk and exposures of potential customers and their properties to validate building characteristics and liability hazards, verify that the property risk is commensurate with the insurance rate or premium, or determine whether to accept the risk and insure the properties, which is a process known as underwriting. Typically, insurance providers factor home inspection results into the underwriting process to gain a more accurate gauge of the insurance policy, its coverage, and whether to issue the insurance policy. For example, a home inspector can inspect the roof, basement, heating system, water heater, air-conditioning system, structure, plumbing, electrical, fire and/or safety issues, and/or any other aspects of buildings or properties that may require repairs, have maintenance issues, or otherwise affect the conditions of the properties. The home inspectors provide inspection reports to the insurance providers for the insurance providers to use to underwrite associated property insurance policies.

However, the home inspection process can be costly for some insurance providers. In particular, home inspection costs can include costs for a home inspector to inspect the property, take photographs of the property, and process the inspection report or any supplemental questionnaires. The home inspections can lead to increased costs for insurance providers, which can become passed-through costs to customers.

Accordingly, there is an opportunity to develop systems and methods for leveraging predictive modeling and existing data to process property insurance policies, and in particular, to process property insurance policies without the added cost of conducting manual home inspections.

### SUMMARY

In an embodiment, a computer implemented method of processing property insurance is provided. The method comprises receiving an application for property insurance for a property and determining a property rating score for the property based on a first set of information associated with the property. The method further comprises analyzing, by a processor, at least one of the property rating score and a second set of information associated with the property and, based on the analyzing, determining whether a manual inspection for the property is needed to approve a policy for the property insurance.

In another embodiment, a system for processing property insurance is provided. The system comprises a communication module adapted to receive an application for property insurance for a property, a parsing module adapted to examine the application to identify a first set of data associated with the property, a memory adapted to store a second set of data associated with the property, and a processor adapted to interface with the communication module, the parsing module, and the memory. The processor is configured to execute computer executable instructions stored in the memory to cause the processor to determine a property rating score for the property based on the first set of information associated with the property, analyze at least one of the property rating score and the second set of information associated with the property and, based on the analyzing, determine whether a manual inspection for the property is needed to approve a policy for the property insurance.

### BRIEF DESCRIPTION OF THE DRAWINGS

FIG. 1 depicts an example environment including components and entities associated with processing property insurance in accordance with some embodiments.

FIG. 2 depicts an example diagram associated with processing property insurance using predictive modeling and existing data in accordance with some embodiments.

FIG. 3 depicts an example interface associated with processing property insurance using predictive modeling and existing data in accordance with some embodiments.

FIG. 4 depicts an example interface associated with processing property insurance using predictive modeling and existing data in accordance with some embodiments.

FIG. 5 depicts a flow diagram of processing property insurance using predictive modeling and existing data in accordance with some embodiments

FIG. 6 is a block diagram of a computing device in accordance with some embodiments.

### DETAILED DESCRIPTION

The novel methods and systems disclosed herein generally relate to leveraging predictive modeling and existing property data to process property insurance applications received from customers. According to embodiments, a customer can submit an application for property insurance to an insurance provider. After receiving of the application, the insurance provider may leverage various information associated with a particular property to determine a “property rating score” for the property. The insurance provider may also apply various business rules or metrics associated with additional information of the property to determine if a manual inspection is necessary to approve an insurance policy for the property. According to some embodiments, the business rules or metrics may be identified and/or stored by the insurance provider prior to receiving the application for the property insurance. Further, in embodiments, the insurance provider may determine the need for a manual inspection based on one or more of the property rating score and the various business rules or metrics, using various predictive modeling techniques.

In some cases if a manual inspection is not needed, the insurance provider can issue the insurance policy and enable the customer to purchase the insurance policy, or in some cases modify and then issue the insurance policy. In other cases if a manual inspection is needed, the insurance provider (or a user or administrator associated therewith) can schedule a home inspection for the property, examine a resulting inspection report, optionally modify the insurance policy, and issue the insurance policy. In further cases, the insurance provider can determine to decline insurance coverage on the property.

The property insurance processing techniques as discussed herein result in an effective, efficient, and cost-saving way to improve property insurance processing. By filtering out which properties do not need to be manually inspected, insurance providers can have a decreased turnaround time for issuing insurance policies to customers. Further, the costs for the insurance policies may decrease as a result of not conducting home inspections. Accordingly, profits for the insurance providers may increase and/or the price of the insurance policies for the customers may decrease. Additionally, the predictive modeling techniques can result in a more accurate model capable of improving over time.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

Accordingly, the term “insurance policy,” as used herein, generally refers to a contract between an insurer and an insured. In exchange for payments from the insured, the insurer pays for damages to the insured which are caused by covered perils, acts or events as specified by the language of the insurance policy. The payments from the insured are generally referred to as “premiums,” and typically are paid on behalf of the insured over time at periodic intervals. The amount of the damages payment is generally referred to as a “coverage amount” or a “face amount” of the insurance policy. An insurance policy may remain (or have a status or state of) “in-force” while premium payments are made during the term or length of coverage of the policy as indicated in the policy. An insurance policy may “lapse” (or have a status or state of “lapsed”), for example, when premium payments are not being paid, when a cash value of a policy falls below an amount specified in the policy (e.g., for variable life or universal life insurance policies), or if the insured or the insurer cancels the policy.

The terms “insurer,” “insuring party,” and “insurance provider” are used interchangeably herein to generally refer to a party or entity (e.g., a business or other organizational entity) that provides insurance products, e.g., by offering and issuing insurance policies. Typically, but not necessarily, an insurance provider may be an insurance company.

An insurance provider may provide one or more different types of insurance, insurance products, insurance services, or insurance policies (collectively referred to herein as “insurance products”). Types of insurance products may include, for example, auto insurance; homeowners insurance; condominium owner insurance; renter's insurance; life insurance (e.g., whole-life, universal, variable, term, etc.); health insurance; disability insurance; long-term care insurance; annuities; business insurance (e.g., property, liability, commercial auto, workers compensation, professional and specialty liability, inland marine and mobile property, surety and fidelity bonds, etc.); boat insurance; insurance for catastrophic events such as flood, fire, volcano damage and the like; motorcycle insurance; farm and ranch insurance; personal article insurance; personal liability insurance; personal umbrella insurance; community organization insurance (e.g., for associations, religious organizations, cooperatives, etc.); and other types of insurance products. In embodiments as described herein, the insurance providers process property insurance policies, although processing other insurance policies is also envisioned. In particular, as described herein, property insurance can be understood to cover various properties, such as homes, apartments, business, condos, churches, rental dwellings, and/or any other type of property.

The terms “insured,” “insured party,” and “policyholder” are used interchangeably herein to refer to a person, party, or entity (e.g., a business or other organizational entity) that is covered by the insurance policy, e.g., whose insured article or entity (e.g., property, life, health, auto, home, business, etc.) is covered by the policy. A “guarantor,” as used herein, generally refers to a person, party or entity that is responsible for payment of the insurance premiums. The guarantor may or may not be the same party as the insured, such as in situations when a guarantor has power of attorney for the insured. An “annuitant,” as referred to herein, generally refers to a person, party or entity that is entitled to receive benefits from an annuity insurance product offered by the insuring party. The annuitant may or may not be the same party as the guarantor.

Typically, a person or customer (or an agent of the person or customer) of an insurance provider fills out an application for an insurance policy. The application may undergo underwriting to assess the eligibility of the party and/or desired insured article or entity to be covered by the insurance policy, and, in some cases, to determine any specific terms or conditions that are to be associated with the insurance policy, e.g., amount of the premium, riders or exclusions, waivers, and the like. Upon approval by underwriting, acceptance of the applicant to the terms or conditions, and payment of the initial premium, insurance policy may be in-force, e.g., the policyholder is enrolled.

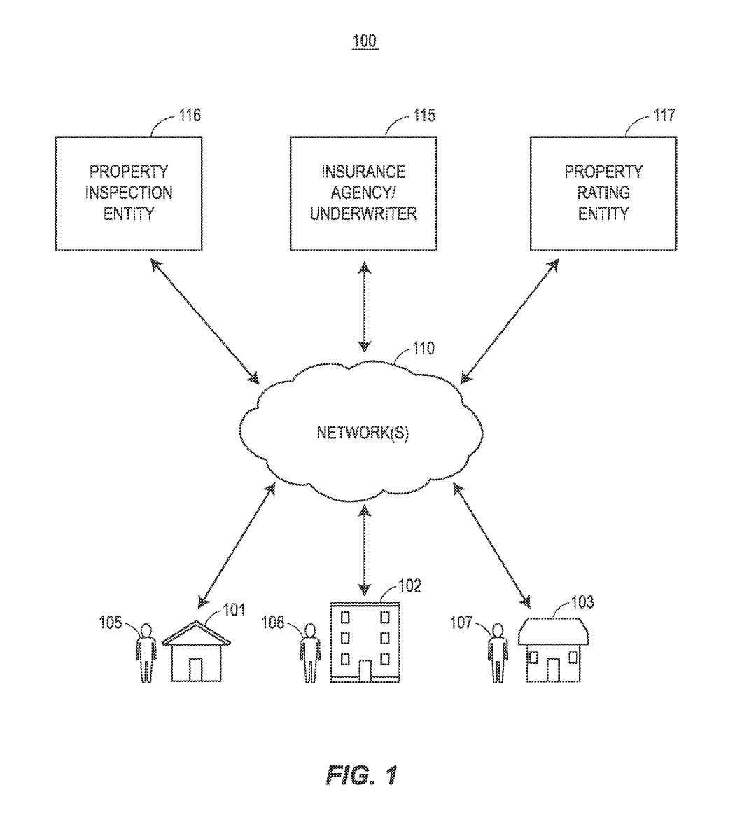

FIG. 1 depicts an example environment 100 associated with processing applications associated with property insurance. Although FIG. 1 depicts certain entities and components, it should be appreciated that additional or alternate entities and components are envisioned.

As shown in FIG. 1, the environment 100 includes example customers 105, 106, 107. In embodiments, the customers 105, 106, 107 may be individuals, groups of individuals, condominium associations, or other entities that may require property insurance. The customers 105, 106, 107 may own respective properties 101, 102, 103 for which property insurance is desired. Although only three customers 105, 106, 107 with three respective properties 101, 102, 103 are depicted in FIG. 1, it should be appreciated that fewer or more customers are envisioned. The respective properties 101, 102, 103 may be homes, condominiums, co-ops, commercial properties, or any other types of real properties. According to embodiments, each of the customers 105, 106, 107 may use a computing device (not shown in FIG. 1) to communicate with an insurance agency/underwriter “insurer” 115 via a network 110 such as, for example, a wide area network (WAN), a local area network (LAN), a personal area network (PAN), or other networks. The network 110 can facilitate any type of data communication via any standard or technology (e.g., GSM, CDMA, TDMA, WCDMA, LTE, EDGE, OFDM, GPRS, EV-DO, UWB, IEEE 802 including Ethernet, WiMAX, WiFi, Bluetooth, and others).

According to embodiments, the insurer 115 can process insurance applications for one or more of the customers 105, 106, 107 and determine whether to issue property insurance (or other types of insurance) policies for one or more of the customers 105, 106, 107 and their respective properties 101, 102, 103. One or more of the customers 105, 106, 107 can submit property insurance applications to the insurer 115 via the network 110. For example, the customer 105 can submit an application or otherwise initiate insurance processing via a website associated with the insurer 115. It should be appreciated that the customers 105, 106, 107 may visit a physical location associated with the insurer 115 to apply for or otherwise obtain property insurance (i.e., the customers 105, 106, 107 may seek property insurance without need for the network 110). It should be appreciated that the insurer 115 is capable of acting as both an agency-brokerage to process insurance applications and issue insurance policies as well as an underwriter to price insurance policies based on various factors and parameters; although it is envisioned that multiple entities that perform these respective services are envisioned.

Referring to FIG. 1, the environment 100 further includes a property inspection entity 116. According to embodiments, the property inspection entity 116 can be an individual, company, business, service, or the like having one or more home inspectors who have the training and certifications to perform home inspections whose data can be used by the insurer 115 to underwrite property insurance policies. For example, a home inspector can inspect the roof, basement, heating system, water heater, air-conditioning system, structure, plumbing, electrical, fire and/or safety issues, and/or any other aspects of buildings or properties that may require repairs, have maintenance issues, or otherwise affect the conditions of the properties. The property inspection entity 116 may provide an inspection report or similar document to the insurer 115 for the insurer 115 to use to underwrite property insurance policies or otherwise determine whether to issue the property insurance policies. According to embodiments, the insurer 115 may interface or communicate with the property inspection entity 116 directly or via the network 110. It should be appreciated that the property inspection entity 116 and the insurer 115 may be combined into a single entity.

The environment 100 as shown in FIG. 1 further includes a property rating entity 117. According to embodiments, the property rating entity 117 can be an individual, company, business, service, or the like that can use various data about a property to calculate a score, metric, or parameter that rates one or more aspects associated with the property. For example, the property rating entity 117 can be LexisNexis® and its Home Inspection Index calculation that identifies and prioritizes properties most likely to have an actionable inspection discovery. As described herein, the property rating entity 117 can use data from the insurance application (e.g., an identification of one of the customers 105, 106, 107, the respective property 101, 102, 103 sought to be insured, the location of the property, etc.) to calculate a score for the property (“property rating score”) that represents a propensity for requiring a manual inspection of the property. It should be appreciated that the property rating entity 117 can use various combinations of the data to calculate the property rating score for the property. Further, it should be appreciated that the property rating score may be a single metric (e.g., an integer on a scale of 1-10) or a combination of a single or multiple metrics and descriptions of various factors. According to embodiments, the insurer 115 may interface or communicate with the property rating entity 117 directly or via the network 110. It should be appreciated that the property rating entity 117 and the insurer 115 (and the property inspection entity 116) may be combined into a single entity, and/or that the insurer 115 may also have capabilities to calculate the property rating score. In some embodiments, the insurer 115 may identify or calculate the property rating score on its own without interfacing with the property rating entity 117. In some optional embodiments, the insurer 115 can use the property rating score to determine an initial decision of whether a manual home inspection is needed for the property for which property insurance is being sought.

According to embodiments, the insurer 115 can use the property rating score from the property rating entity 117 as well as its own business rules, metrics, parameters, or the like, in addition to any additional retrieved or accessed data (e.g., internal data, public record data, customer data, aerial imaging data, and/or the like), to determine if a manual home inspection is needed for the property for which property insurance is being sought. For example, the insurer 115 can use various data points or parameters for the property such as year built, home size, earthquake and wildfire data, weather data, distance from public services, whether the property has a pool, sinkhole risk data, coastal proximity data, solid fuel appliance data, and/or other specific property data. In some embodiments, the insurer 115 may retrieve various data points or parameters for the applicable properties 101, 102, 103 from a third-party server or entity (not shown in FIG. 1) and/or from an application for property insurance. The manual home inspection determination can enable the insurer 115 to determine the presence of a risk not identified by the property rating entity 117 (or the property rating score thereof), whereby the risk may “trigger” a manual inspection (i.e., the insurer 115 may deem a manual inspection necessary based on the risk).

Based on the insurer 115 determining whether a manual home inspection is necessary, the insurer 115 can interface with the property inspection entity 116 to create a work item or otherwise schedule a home inspection for the given property. According to embodiments, the property inspection entity 116 can perform the home inspection and provide results of the home inspection to the insurer 115, and the insurer 115 can underwrite and issue an insurance policy based on the home inspection results. In some embodiments in which the insurer 115 determines that a manual inspection is not necessary (e.g., if there are no identified risks), the insurer 115 can underwrite and issue the insurance policy based on the property data and/or other parameters. In some embodiments, the insurer 115 may modify the parameters for the insurance policy or decline property insurance coverage.

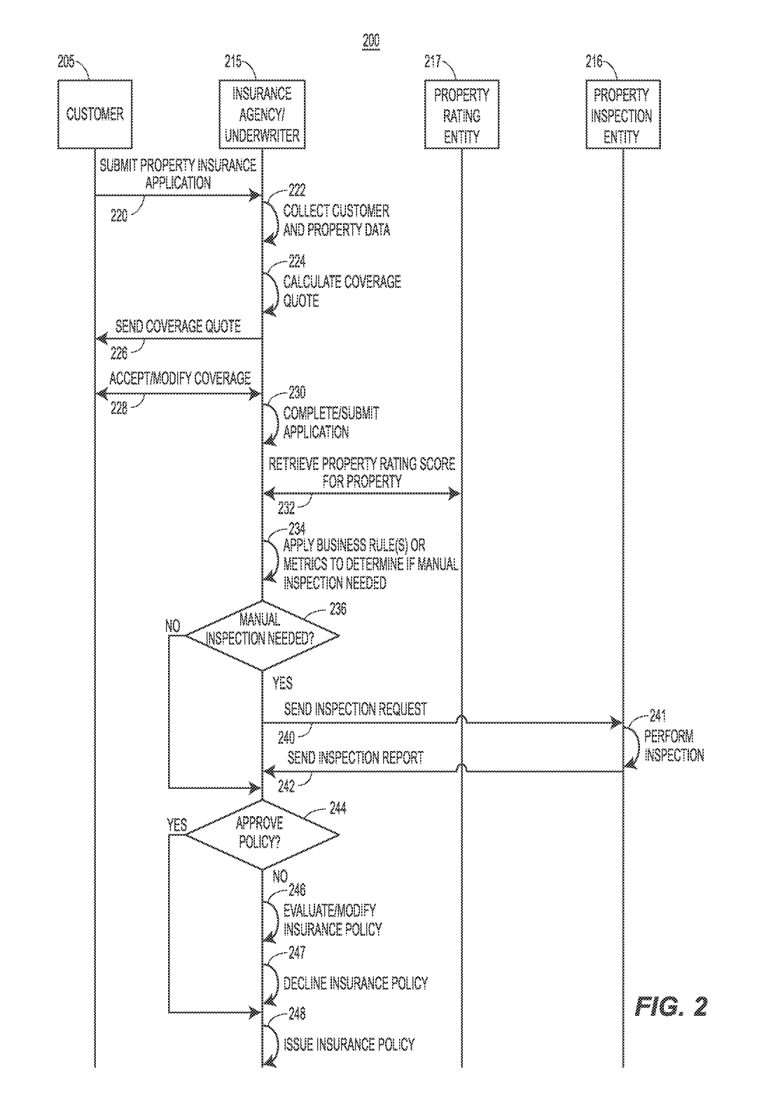

Referring to FIG. 2, depicted is a diagram 200 illustrating techniques for processing property insurance policies for customers. In particular, FIG. 2 includes a customer 205 (such as the customer 105 as described with respect to FIG. 1), an insurance agency/underwriter (“insurer”) 215 (such as the insurer 115 as described with respect to FIG. 1, or a user/administrator/underwriter associated therewith), a property rating entity 217 (such as the property rating entity 117 as described with respect to FIG. 1), and a property inspection entity 216 (such as the property inspection entity 116 as described with respect to FIG. 1).

As shown in FIG. 2, the customer 205 can submit 220 a property insurance application for a property (such as the property 101 as described with respect to FIG. 1) to the insurer 215. According to some embodiments, the customer 205 can interface with a system of the insurer 215 (e.g., a website) to submit the property insurance application. The insurer 215 can collect 222 customer data as well as data associated with the property. In some embodiments, the customer and property data can be included in the insurance application or stored by the insurer 215. For example, the customer and property data can include various customer and property identification data (e.g., name, age, address, etc.), as well as insurance history information, structure information, household information, effective date(s), desired coverage(s), protective device information (e.g., smoke detectors, fire alarms, etc.), options and endorsements information, and/or other data.

The insurer 215 can calculate 224 a coverage quote for the property insurance. According to embodiments, the coverage quote can be based on the risk associated with the customer and property data. The insurer 215 can send 226 or otherwise provide the coverage quote to the customer 205 (e.g., via a website of the insurer 215). The customer 205 and the insurer 215 can accept or modify 228 the coverage based on various factors, such as the customer 205 changing desired coverage options, effective dates, and/or other factors. The insurer 215 can complete/submit 230 the property insurance application, such as in response to the customer 205 selecting to proceed with the coverage quote.

In embodiments, the insurer 215 completing/submitting the property insurance application can trigger a property rating score calculation. As shown in FIG. 2, the insurer 215 can retrieve 232 the property rating score for the property from the property rating entity 217. According to embodiments, the insurer 215 can provide an identification of the customer 205, the property, a year that the property was built, and/or the location of the property (and/or other data) to the property rating entity 217, the property rating entity 217 can calculate the property rating score based on the provided data, and the property rating entity 217 can send the calculated property rating score to the insurer 215. It should be appreciated that the insurer 215 may calculate the property rating score itself based on various data. In some cases, the property rating score may trigger the need for a manual inspection, in which case processing can proceed to 240 (or to other functionality). Otherwise, processing can proceed to block 234 (or to other functionality).

The insurer 215 can apply 234 business rules or metrics to determine if a manual inspection is needed. As discussed herein, the business rules and metrics can correspond to various data points or parameters for the property such as year built, home size, earthquake and wildfire data, weather data, distance from public services, whether the property has a pool, crime data near the property, and/or other data. In some cases, the data points or parameters can be identified from the property insurance application. According to embodiments, the business rules or metrics application can identify one or more risks that were not identified by the property rating entity 217 in calculating the property rating score. The one or more risks may trigger the necessity of a manual inspection for the property. For example, the application of the business rules may result in a wildfire risk for the property, which the insurer 215 may deem necessitates a manual inspection. It should be appreciated that the insurer 215 can employ various predictive modeling techniques and calculations to determine the need for a manual inspection including, for example, regression, decision trees, neural networks, association rules, clustering, support vector machines, and/or others.

Based on either the property rating score or the application of the business rules or metrics, a manual home inspection may or may not be necessary (block 236). According to some embodiments, the property rating score may trigger a manual home inspection independent from the application of the business rules or metrics, and vice-versa. In further embodiments, the insurer 215 may determine the need for a manual inspection based on a combination of the property rating score and the application of the business rules or metrics (e.g., by weighting the combination according to various degrees). If the insurer 215 determines that a manual inspection is necessary (“YES”), processing can proceed to 240 (or to other functionality). If the insurer 215 determines that a manual inspection is not necessary (“NO”), processing can proceed to 244 (or to other functionality). At 240, the insurer 215 can send an inspection request to the property inspection entity 216. In some embodiments, a third party entity or vendor, such as an aggregator entity, can be used to facilitate communication between the insurer 215 and the property inspection entity 216. In particular, the insurer 215 can send the section request to the third party entity, which can forward the inspection request to the property inspection entity 216. Further, the property inspection entity 216 can send an inspection report to the third party entity, which can forward the inspection report to the insurer 215. According to embodiments, the property inspection entity can perform 241 an inspection of the property and send 242 an inspection report corresponding to the property to the insurer 215.

At 244, the insurer 215 can determine whether to approve the property insurance policy, for example based on the inspection report from the property inspection entity 216, if applicable. It should be appreciated that the insurer 215 can determine policy approval based on other factors, such as poor claim history, damage to buildings, location-specific concerns, and/or others. If the insurer 215 determines to not approve the property insurance policy (“NO”), the insurer 215 can evaluate and/or modify 246 the insurance policy. According to embodiments, the insurer 215 can create and assign a work item to have an individual examine the desired coverage, the inspection report, and/or other data, and appropriately modify the insurance policy. In some cases, the insurer 215 may decline 247 to offer property insurance for the property and may inform the customer 205 of the declination. In other cases, the insurer 215 may offer the modified insurance policy to the customer 205 and the customer 205 may accept or decline accordingly. If the customer 205 accepts the modified insurance policy (or the insurer 244 determines to approve the policy in 244 (“YES”)), the insurer 215 can issue 248 the insurance policy. In some cases, the insurer 215 can enable the customer 205 to purchase the insurance policy, such as via a system (e.g., a website of the insurer 215).

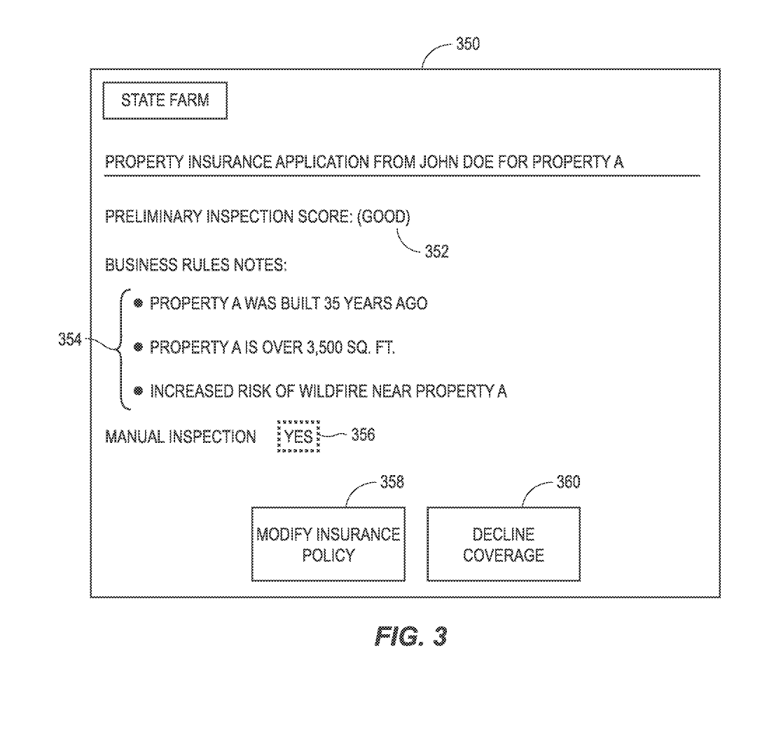

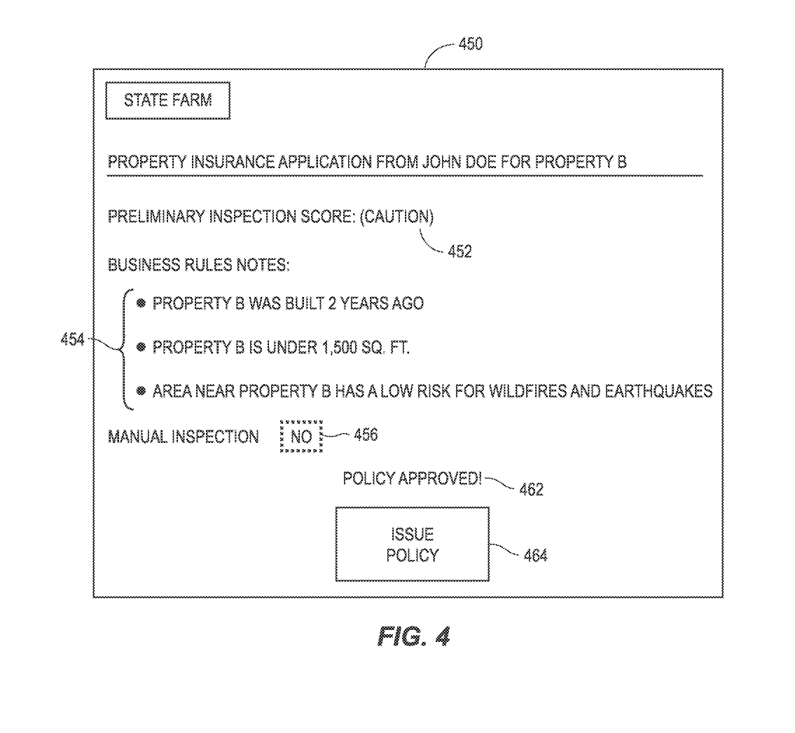

Referring to FIGS. 3 and 4, depicted are two example interfaces that may be associated with an insurer, such as the insurer 115 as discussed with respect to FIG. 1. It should be appreciated that the interfaces of FIGS. 3 and 4 include example content and can include substitute or additional content. Further, a server computer or other type of computing device associated with the insurer can be configured to display or present the interfaces, such as via a dedicated software application of the server computer. For example, an insurance agent or underwriter may access the server computer to interface with the content and functionalities as described herein.

Referring to FIG. 3, depicted is an example interface 350 associated with an example property insurance application. Specifically, the interface 350 indicates that the application is from “John Doe” for property insurance for “Property A.” The interface 350 indicates an example preliminary inspection score (e.g., the LexisNexis® Home Inspection Index) (352) of “Good” to indicate that, according to the preliminary inspection score 352, Property A has a lesser need for a manual inspection (or otherwise that the preliminary inspection score 352 did not trigger the necessity for a manual inspection). It should be appreciated that other various property rating scores according to other scales are envisioned. For example, the preliminary inspection score may be based on a numerical scale. The interface 350 can also include a set of business rules notes 354. More particularly, the business rules notes 354 can indicate relevant information as a result of the insurer analyzing various data about the property and the application as well as pricing data and other data used to price or underwrite a property insurance policy (e.g., any data to which the property rating entity may not have access).

As shown in FIG. 3, the business rules notes 354 can indicate that Property A was built 35 years ago, that Property A is over 3,500 square feet, and that the area near Property A experiences an increased risk of wildfire (i.e., qualities indicative of a greater need for a manual inspection or qualities that, individually or collectively, may trigger a need for a manual inspection). The insurer can apply application data to the business rules notes 354 to determine if there is a need to conduct a manual inspection for the property. As shown in FIG. 3, an inspection indicator 356 indicates that a manual inspection for Property A is needed. The interface 350 includes a modify selection 358 and a decline selection 360. In particular, the modify selection 358 can enable the insurer (and more specifically a user associated with the insurer) to modify the insurance policy, such as coverage type, premium and/or deductible amounts, and/or other information, wherein the modification can be based on the business rules notes 354 and/or the preliminary inspection score 352. The decline selection 360 can enable the insurer to decline property insurance coverage for Property A. For example, the insurer may deem Property A too risky to insure based on the business rules notes 354, the preliminary inspection score 352, and/or the need for the manual inspection.

Referring to FIG. 4, depicted is an example interface 450 associated with another example property insurance application. Specifically, the interface 450 indicates that the application is from “Jane Smith” for property insurance for “Property B.” The interface 450 indicates a preliminary inspection score (452) of “Caution” to indicate that Property B may have a greater need for a manual inspection. According to embodiments, a preliminary inspection score that, in and of itself, warns or cautions of a need for a home inspection (such as the home inspection score 452) may be enough to trigger a manual inspection without the analysis of any business rules. However, it should be appreciated that a preliminary inspection score that warns or cautions of a need for a home inspection may be examined in combination with business rules, such as the example as depicted in FIG. 4. It should be appreciated that other various property rating scores according to other scales are envisioned. The interface 450 can also include a set of business rules notes 454. More particularly, the business rules notes 454 can indicate relevant information as a result of the insurer analyzing various data about the property and the application as well as pricing data and other data used to price or underwrite a property insurance policy (e.g., any data to which the property rating entity may not have access).

As shown in FIG. 4, the business rules notes 454 can indicate that Property B was built two years ago, is under 1,500 square feet, and is in an area that is a low risk for wildfires and earthquakes (i.e., qualities indicative of a lesser need for a manual inspection or qualities that, individually or collectively, do not trigger a need for a manual inspection). The insurer can apply application data to the business rules notes to determine if there is a need to conduct a manual inspection for the property. In embodiments as shown in FIG. 4, none of the business rules notes 454 trigger a need to conduct a manual inspection for Property B. As shown in FIG. 4, an inspection indicator 456 indicates that a manual inspection for Property B is not needed. Accordingly, the interface 450 indicates that the property insurance policy is approved (462) and includes an issue selection 464 that, when selected by the insurer or a user associated therewith, can issue the property insurance policy and optionally send a notification to the customer (here: Jane Smith).

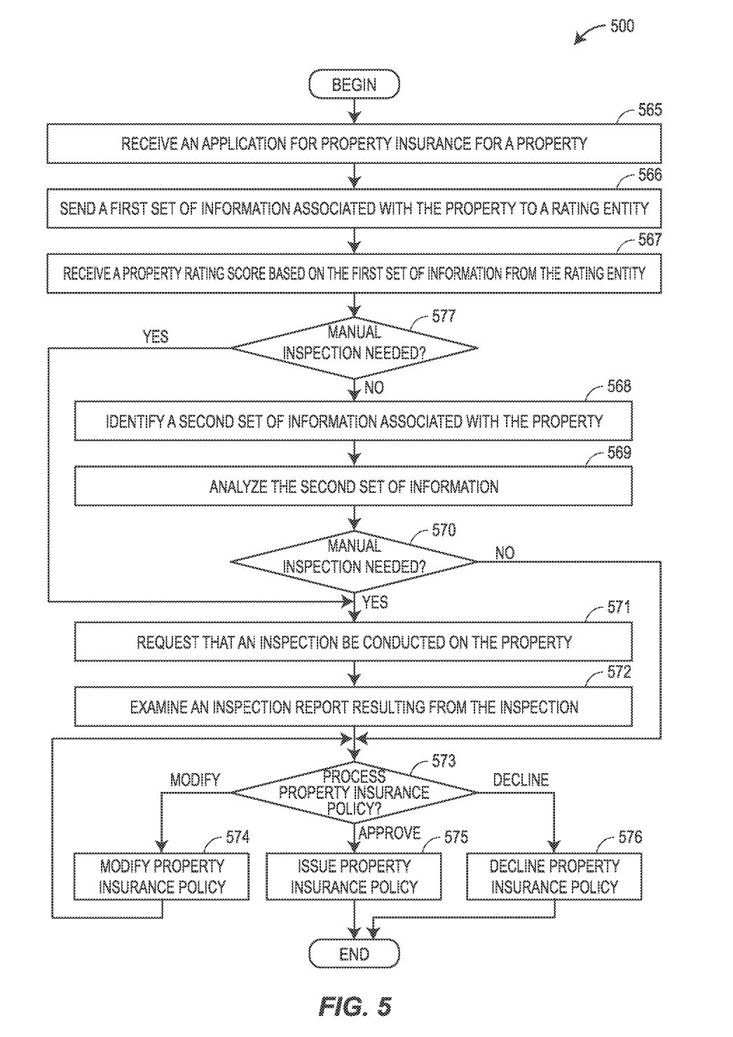

FIG. 5 is an example method 500 of processing property insurance. At least a portion of the method 500 may be performed by one or more computing devices, in an embodiment. For example, the method 500 may be performed by a server associated with the insurer 115 as described with respect to FIG. 1.

The computing device can receive (block 565) an application for property insurance for a property. In embodiments, a customer (such as an individual) can access a system (e.g., a website) associated with an insurer to submit the application. The computing device can send (block 566) a first set of information associated with the property to a rating entity. For example, the first set of information (or a portion thereof) can include an identification of the property, an identification of an applicant for the property insurance, a location of the property, and/or other data or information, and can be included in the application for property insurance. Further, for example, the rating entity can be LexisNexis®. The computing device can receive (block 567), from the rating entity, a property rating score based on the first set of information. In embodiments, the property rating score can reflect a need for the property to undergo an inspection. For example, the property rating score can be the Home Inspection Index available from LexisNexis®. It should be appreciated that the computing device itself can perform the functionalities discussed relative to blocks 566 and 567 to calculate or determine the property rating score based on the first set of information. The computing device can determine (block 577) if a manual inspection is needed based on the property rating score, for example if the property rating score or data related thereto triggers a need for a manual inspection. If a manual inspection is needed (“YES”), processing can proceed to block 571 or to other functionality; and if the manual inspection is not needed (“NO”), processing can proceed to block 568.

At block 568, the computing device can identify a second set of information associated with the property. According to embodiments, the computing device can identify the second set of information (or a portion thereof) from the application for the property insurance and/or from its own data. In some cases, the second set of information can include data associated with a location of the property, a size of the property, and/or other data, information, or business rules or metrics. The computing device can analyze (block 569) the second set of information. In some cases, the computing device can examine the second set of information and apply any business rules to determine if any attributes of the property trigger a need for a manual inspection. According to embodiments, the computing device can analyze the second set of information to determine a need for a manual inspection independent from or in combination with the property rating score.

The computing device can determine (block 570), based the second set of information (and optionally in combination with the property rating score), whether a manual inspection is needed. In some cases, the computing device can provide the property rating score and/or the second set of information to a user or administrator to determine whether the manual inspection is needed. If the manual inspection is needed (“YES”), processing can proceed to block 571 or to other functionality; and if the manual inspection is not needed (“NO”), processing can proceed to block 573. At block 571, the computing device can request that an inspection be conducted on the property. In some cases, the computing device can request a property inspection entity to conduct the inspection or otherwise interface with an inspection management system to schedule the inspection. The computing device can further examine (block 572) an inspection report resulting from the inspection. In embodiments, the inspection report can indicate any problems or issues with the property resulting from the manual inspection. Processing can then proceed to block 573 or to other functionality.

At block 573, the computing device can determine how to process a property insurance policy. According to embodiments, the determination can be based on one or more of the property rating score, the application of the second set of information, and the results from the home inspection report. Further, insurance coverage associated with the property insurance policy can be based on applicant selections and/or coverage options available from the insurance provider. If the computing device determines to modify the property insurance policy (“MODIFY”), the computing device can modify (block 574) the property insurance policy. In some cases, the computing device may need to adjust certain coverage and/or costs associated with the coverage. Processing can then return to block 573 or to other processing. It should be appreciated that a user, administrator, or the like can interface with the computing device to examine the inspection report and determine how to process (or modify) the property insurance policy. For example, an underwriter may examine the home inspection report to determine that the property insurance policy should have an increased deductible.

If the computing device determines to approve the property insurance policy (“APPROVE”), the computing device can issue (block 575) the property insurance policy. In particular, the computing device can enable the customer to purchase the property insurance policy. If the computing device determines to decline the property insurance policy (“DECLINE”), the computing device can decline (block 576) the property insurance policy. In some cases, the computing device can notify the customer of the declination.

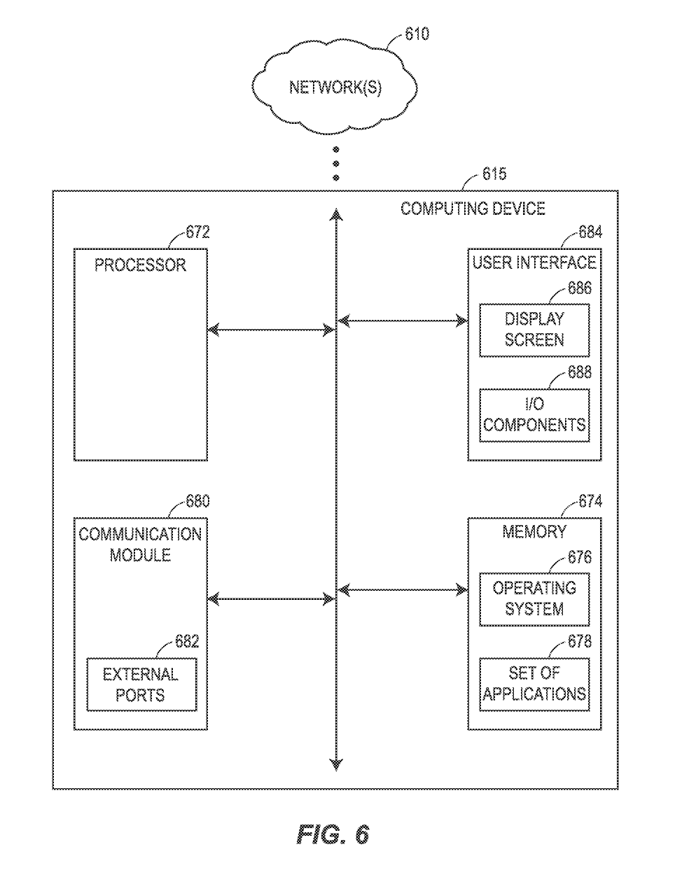

FIG. 6 illustrates an example computing device 615 (such as a server associated with the insurer 115 as discussed with respect to FIG. 1) in which the functionalities as discussed herein may be implemented. The computing device 615 can include a processor 672 as well as a memory 674. The memory 674 can store an operating system 676 capable of facilitating the functionalities as discussed herein as well as a set of applications 678. For example, one of the set of applications 678 can receive and process property insurance applications from customers, as well as perform other functionalities as discussed herein. The processor 672 can interface with the memory 674 to execute the operating system 676 and the set of applications 678. According to embodiments, the memory 674 can also store data associated with the property insurance, including property data and neighborhood data, various business rules, and/or any other data as discussed herein. The memory 674 can include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

The computing device 615 can further include a communication module 680 configured to communicate data via one or more networks 610. According to some embodiments, the communication module 680 can include one or more transceivers (e.g., WWAN, WLAN, and/or WPAN transceivers) functioning in accordance with IEEE standards, 3GPP standards, or other standards, and configured to receive and transmit data via one or more external ports 682. For example, the communication module 680 can receive insurance applications or requests from customers via the network 610. For further example, the computing device 615 can transmit insurance policy modifications and decisions to customers via the communication module 680 and the network(s) 610. The computing device 615 may further include a user interface 684 configured to present information to a user and/or receive inputs from the user. As shown in FIG. 6, the user interface 684 includes a display screen 686 and I/O components 688 (e.g., ports, capacitive or resistive touch sensitive input panels, keys, buttons, lights, LEDs, speakers, microphones, and others). According to embodiments, the user may access the computing device 615 via the user interface 684 to process insurance policies and/or perform other functions. In some embodiments, the computing device 615 can perform the functionalities as discussed herein as part of a “cloud” network or can otherwise communicate with other hardware or software components within the cloud to send, retrieve, or otherwise analyze data.

In general, a computer program product in accordance with an embodiment includes a computer usable storage medium (e.g., standard random access memory (RAM), an optical disc, a universal serial bus (USB) drive, or the like) having computer-readable program code embodied therein, wherein the computer-readable program code is adapted to be executed by the processor 672 (e.g., working in connection with the operating system 676) to facilitate the functions as described herein. In this regard, the program code may be implemented in any desired language, and may be implemented as machine code, assembly code, byte code, interpretable source code or the like (e.g., via C, C++, Java, Actionscript, Objective-C, Javascript, CSS, XML, and/or others). In some embodiments, the computer program product may be part of a cloud network of resources.

Although the foregoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and systems described herein are illustrative only and are not limiting upon the scope of the claims.

1. A method of processing property insurance, the method comprising:
receiving, at a computing device, an electronic application for property insurance for a property;
determining, by one or more processors, a property rating score for the property based on a first set of information associated with the property;
first determining, based on the property rating score, that a manual inspection for the property is needed;
responsive to first determining that the manual inspection for the property is needed:
identifying, from the electronic application, a second set of information associated with the property, the second set of information different from the first set of information, and
analyzing, by the one or more processors, the second set of information associated with the property;
based on the analyzing, subsequently determining, by the one or more processors, that the manual inspection for the property is not needed; and
without requesting that the manual inspection be performed on the property, automatically issuing a policy for the property insurance.

2. (canceled)

3. The method of claim 1, wherein automatically issuing the policy for the property insurance comprises:
determining that the policy for the property insurance is not automatically approved;
modifying the policy for the property insurance; and
issuing the modified policy for the property insurance.

4. The method of claim 1, further comprising:
causing a result of the analyzing to be provided to a user; and
receiving, from the user, an indication that the policy for the property insurance needs to be modified.

5. (canceled)

6. The method of claim 1, wherein the first set of information includes one or more of an identification of the property, an identification of an applicant for the property insurance, a year that the property was built, and a location of the property.

7. The method of claim 1, wherein the second set of information includes one or more of data associated with a location of the property, a size of the property, and data indicating one or more underwriting risks associated with the property.

8. (canceled)

9. The method of claim 1, wherein subsequently determining that the manual inspection for the property is not needed based on analyzing the second set of information comprises:
identifying, from the second set of information, at least one risk associated with the property; and
determining that the at least one risk does not trigger a need for the manual inspection.

10. The method of claim 1, wherein determining the property rating score for the property comprises:
sending the first set of information associated with the property to a rating entity; and
receiving the property rating score from the rating entity.

11. (canceled)

12. A system for processing property insurance, comprising:
a communication module adapted to receive an electronic application for property insurance for a property;
a memory adapted to store information associated with the property;
a processor adapted to interface with the communication module and the memory, wherein the processor is configured to execute computer executable instructions stored in the memory to cause the processor to:
determine a property rating score for the property based on a first set of information associated with the property,
first determine, based on the property rating score, that a manual inspection for the property is needed,
responsive to first determining that the manual inspection for the property is needed:
identify, from the electronic application, a second set of information associated with the property, the second set of information different from the first set of information, and
analyze the second set of information associated with the property,
based on the analyzing, subsequently determine that the manual inspection for the property is not needed, and
without requesting that the manual inspection be performed on the property, automatically issue a policy for the property insurance.

13. (canceled)

14. The system of claim 12, wherein the processor automatically issues the policy for the property insurance by:
determining that the policy for the property insurance is not automatically approved,
modifying the policy for the property insurance, and
issuing the modified policy for the property insurance.

15. The system of claim 12, wherein the processor is further configured to:
cause a result of the analyzing to be provided to a user, and
receive, from the user, an indication that the policy for the property insurance needs to be modified.

16. (canceled)

17. The system of claim 12, wherein the first set of information includes one or more of an identification of the property, an identification of an applicant for the property insurance, a year that the property was built, and a location of the property.

18. The system of claim 12, wherein the second set of information includes one or more of data associated with a location of the property, a size of the property, and data indicating one or more underwriting risks associated with the property.

19. (canceled)

20. The system of claim 12, wherein the processor subsequently determines that manual inspection for the property is not needed based on analyzing the second set of information by:
identifying, from the second set of information, at least one risk associated with the property, and
determining that the at least one risk does not trigger a need for the manual inspection.

21. The system of claim 12, wherein the processor determines the property rating score for the property by:
sending the first set of information associated with the property to a rating entity, and
receiving the property rating score from the rating entity.

22. (canceled)
